(19) United States
(12) Patent Application Publication
(10) Pub. No.: US 2010/0064438 A1
(43) Pub. Date: Mar. 18, 2010

(54) LIFTING COLUMN FOR HOSPITAL OR CARE BEDS

(75) Inventors: Martin K. Knudsen, Sydals (DK); René Sørensen, Grasten (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: Linak A/S

(21) Appl. No.: 12/312,282

(22) PCT Filed: Nov. 5, 2007
(86) PCT No.: PCT/DK2007/000481

§ 371 Date: May 4, 2009

(30) Foreign Application Priority Data
Nov. 3, 2006 (DK) PA 2006 01425
Nov. 14, 2008 (DK) PA 2006 01480

(51) Int. Cl. A61G 7/012; B66F 3/22; A61G 7/002

(52) U.S. Cl. 5/611; 254/122

(57) ABSTRACT

A lifting column comprising a number of telescopic members and a drive unit for extension of the members located internally herein. The column is intended for hospital and care beds of the art comprising a column at each end in its longitudinal centre plane and connected to the lower frame (1) and the upper frame (2) respectively so that the height of the upper frame can be adjusted by activating the drive unit of the lifting columns. This drive unit is a scissor mechanism constructed as a separate unit with two identical interconnected scissors (6, 7) located between a bottom and top element (8, 9) and by the longitudinal edges of these plates. A linear actuator (18) is, with its one end, secured to one of the bottom and top element and the other end secured to an interconnection element (16) between the two scissors. The scissor mechanism hereby becomes particularly rigid and the telescopic members can thus be constructed as a simple enclosure without stability.

The present invention relates to a lifting column comprising a number of telescopic members and a drive unit, located internally herein, for extension of the members, said lifting column being intended for hospital and care beds of the art comprising a lower frame and an upper frame for a mattress and where a lifting column, located under the bed at each end in its vertical longitudinal centre plane, is connected, at respective ends, to the lower frame and the upper frame respectively so that the height of the upper frame may be adjusted by activating the drive unit of the lifting columns and where the drive unit comprises a scissor mechanism with at least two sections and driven by a motor driven spindle.

This type of lifting columns is for instance known from DE 201 16 130 U1. The scissor mechanism here comprises two and a half link, where the free ends of the upper link is secured to a separate spindle nuts on a horizontal spindle with a left- and right-handed thread respectively on each half. The spindle is driven by a gear motor and when rotated, the spindle nuts are pulled towards each other which causes the scissor to extend and by reversing the direction of rotation, the spindle nuts are pushed apart, causing the scissor to retract.

From WO 03/073974 A1 another construction is known, where the scissor comprises two links between which, a vertical motor driven spindle is in engagement with a spindle nut on separate links in the scissor. Likewise, the spindle has a right and left-handed thread on each half. When the spindle is rotated in one direction, the spindle nuts are pushed apart, causing the scissor to be extended and when reversed, the scissor is retracted, as the nuts are then moved towards each other.

Another construction is known from FR 2 780 638, where a motor driven spindle located next to the scissor is in engagement with a spindle nut secured to the connection between the two links of the scissor. When the spindle is rotated in one direction, the scissor is extended and when the direction of rotation is reversed, the scissor is retracted.

In DE 201 16 130 U1 and FR 2 780 638 the scissor is placed vertically, so to understand that it is secured to the bottom of the column with a pivotal point between two links. In WO 03/073974 the scissor is in a reclining position i.e. the scissor is secured to the bottom of the column with the ends of two legs in a link.

As only two lifting columns are located under the bed at each end of its longitudinal centre plane, large demands are required on the stability of the column both in the traverse and in the longitudinal direction. Single scissor mechanisms as in FR 2 780 638 and WO 03/073974 A1 do not as such posses the necessary stability for which reason the stability must be transferred to the guide, i.e. the telescopic members. Even though the scissor mechanism in DE 201 16 130 U1 has two parallel scissors, they appear as a single scissor and the stability is thus also transferred to the guides in the telescopic members, cf. for instance FIG. 10. When the stability is transferred to the telescopic members, said telescopic members must be designed in preparation for this, which causes the design to be relatively complicated and pricey.

The construction and design of the scissor is complicated in that the spindle and spindle nuts are integrated therein, cf. for instance WO 03/073974 A1.

Another problem by scissor mechanisms is that they require a major starting torque from the retracted position.

The object of the invention is to provide a remedy solution for the mentioned disadvantages of the columns of the art stated in the introductory portion.

This is achieved according to the invention by designing the scissor mechanism as a separate scissor, and employing a linear actuator. As spindle and spindle nut are not integrated in the scissor, this may be designed optimum with reference to the stability. By employing two identical interconnected scissors placed between a bottom and a top element and by the longitudinal edges of these elements, the stability may be increased further. In that the linear actuator with one end is secured to on of the elements and with the other end secured to a connection element between the two scissors, a good force application on these is attained. When the actuator is placed halfway between the two scissors, said scissors can be placed with the largest possible mutual distance within the cross section of the column and at the same time, the force application becomes uniform. When the actuator is not integrated in the scissor mechanism, but is a separate actuator, the scissor mechanism may be designed in a more optimum manner. A separate actuator also provides the possibility for replacing it in case it should break down and, very importantly, different types of actuators may be used, depending on the specific context into which the column must enter. The scissors are with one set of ends pivotally hinged to the top and bottom elements and with the other set of ends placed displaceable in relation to these. This is a relatively simple way of mounting, the displacement may be carried out with sliding blocks in guide way or it can be guide rods mounted on the top and bottom elements. When, at least, one set of links of the two scissors is constructed as frames, a particular rigid construction of the scissor is attained, which is further pronounced, when the slide blocks are rigidly connected for instance to a plate element. In this construction all of the stability is located in the scissor mechanism so that the telescopic members may be constructed without stability and thus as a simple enclosure, simply for counteracting something from being jammed in the scissor mechanism and also to function as dust and humidity guard. Designwise, this provides more freedom in respect to the desgning of the appearance of the column, which on the whole is only represented by the enclosure

As mentioned above, a relatively high torque is required when extending the scissor from retracted position. By employing at least one spring element, which is prestressed when the scissor is retracted, this contributes to overcoming the starting torque and smaller motors may thus be used. The spring element could for instance be a screw spring or gas spring and expediently two are used placed symmetrically around the longitudinal axis of the actuator.

Further features of the invention will be elucidated in connection with the following description of an embodiment according to the invention with reference to the accompanying drawing in which,

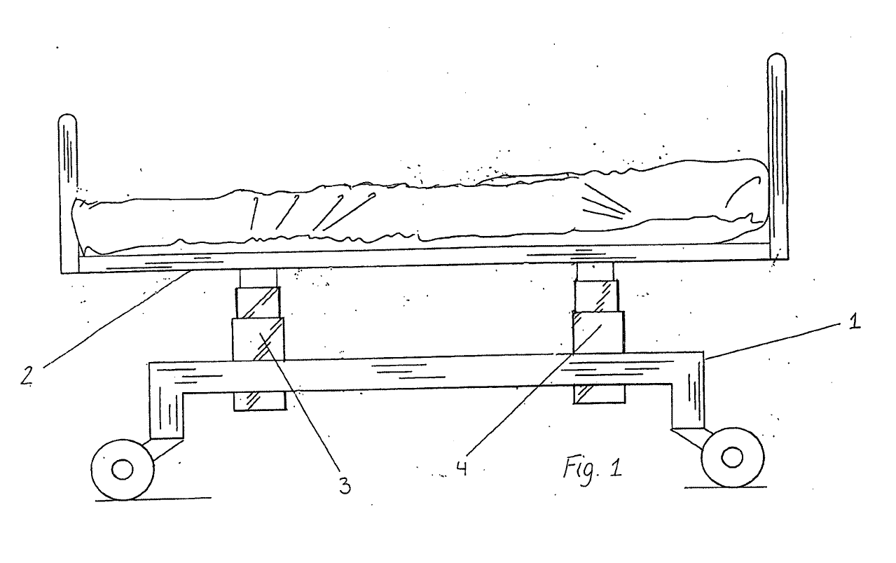

FIG. 1, shows a schematic view of a hospital bed,

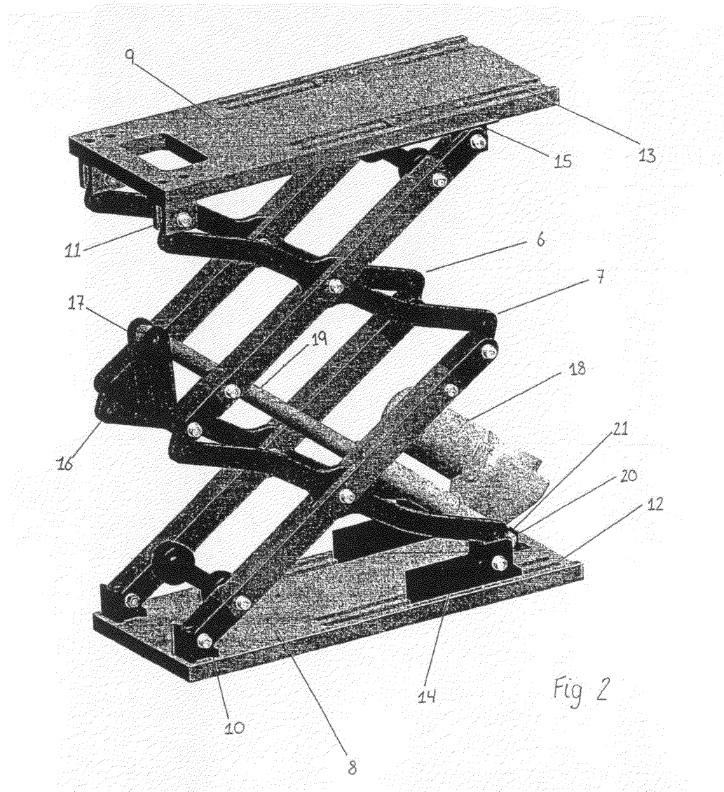

FIG. 2, shows the scissor mechanism in an extended position seen in perspective,

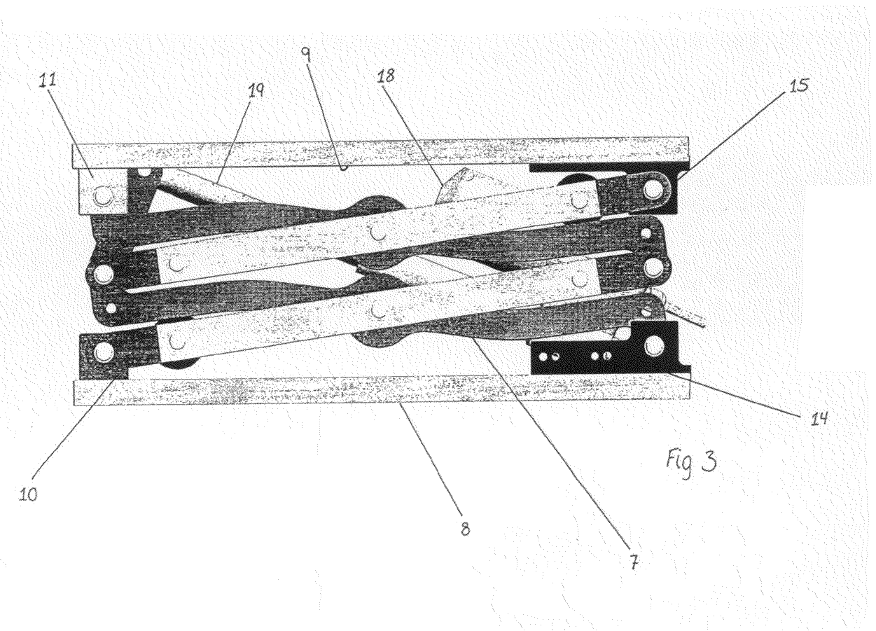

FIG. 3, shows the scissor mechanism in retracted position seen directly from the side,

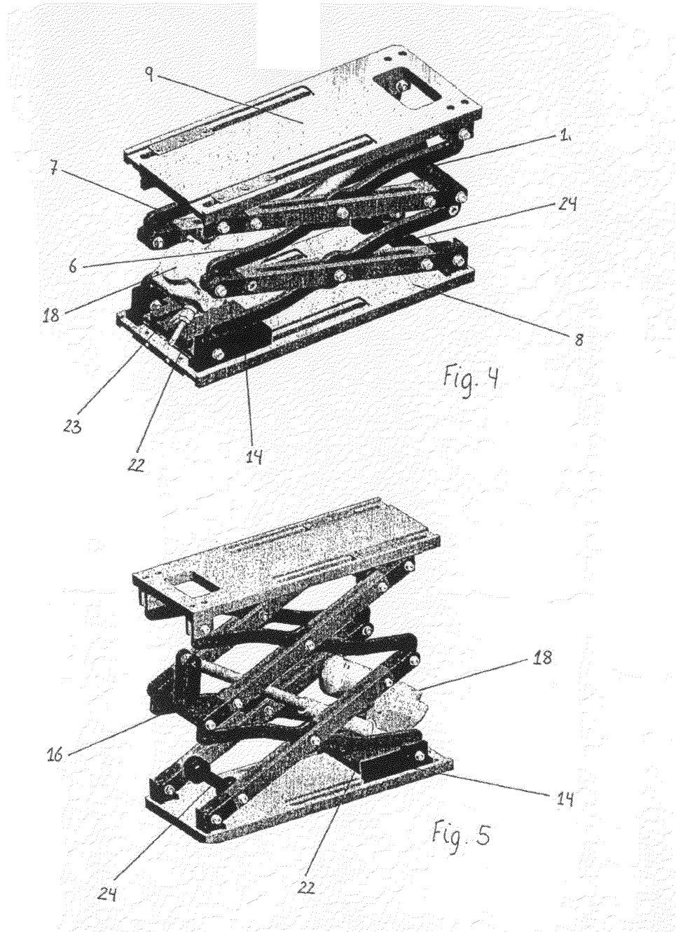

FIG. 4, a further development of the scissor mechanism seen from one side,

FIG. 5, shows the scissor mechanism in FIG. 4 seen from the other side,

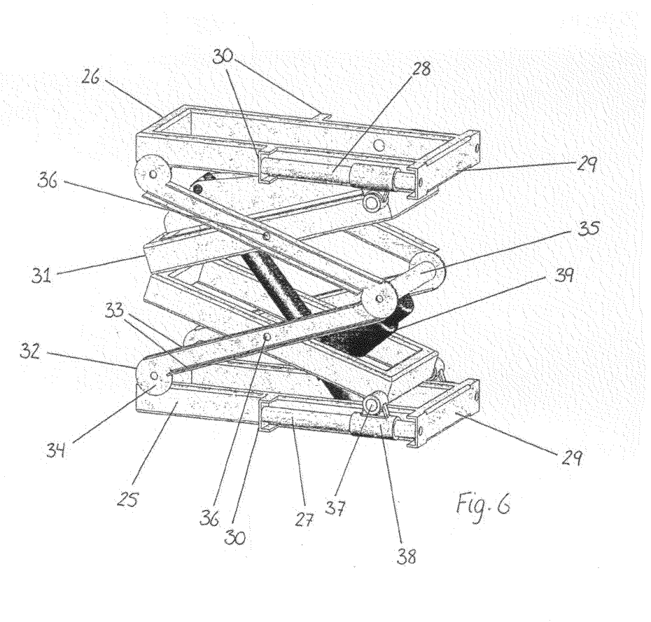

FIG. 6, shows another embodiment of a scissor mechanism according to the invention seen in perspective,

FIG. 7, shows a longitudinal section through the scissor mechanism in FIG. 6, and

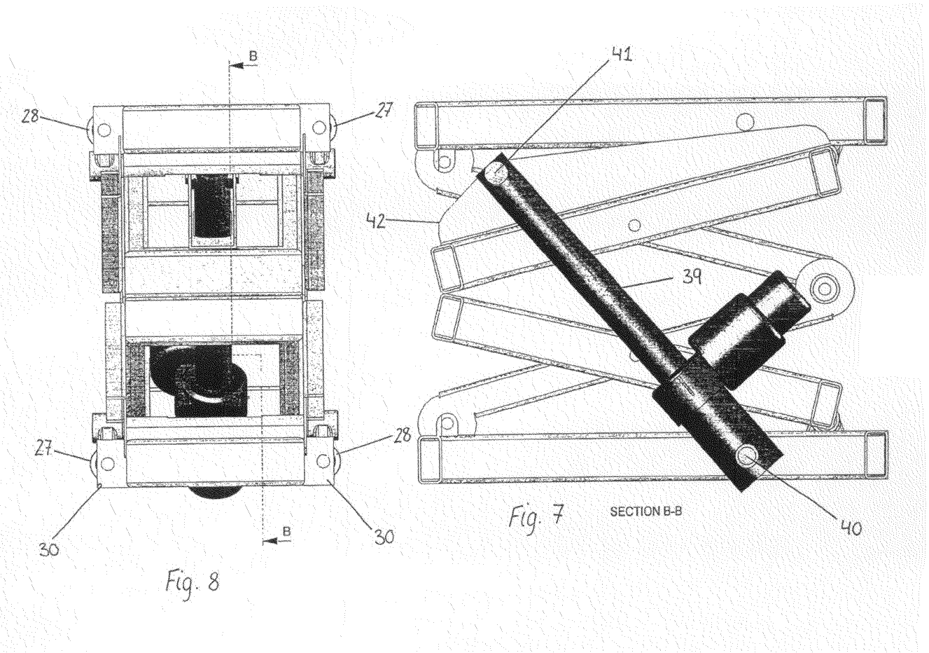

FIG. 8, shows the scissor mechanism in FIG. 6 seen from its left end.

FIG. 1 discloses a hospital bed comprising a lower frame equipped with drive wheels and an upper frame for a mattress, and where a lifting column 3,4 is provided under the bed at each end thereof and in the vertical longitudinal centre plane of the bed. The lifting columns 3,4 are, with respective ends, connected to the lower frame and the upper frame respectively, so that the height of the upper frame above the floor can be adjusted by activating the drive unit of the lifting columns and where the drive unit comprises a scissor mechanism with at least two links and driven by a linear actuator. The drive unit is enclosed by a telescopic guide 5 with three members.

As it appear from FIG. 2 of the drawing, the scissor mechanism comprises two identical scissors 6,7 with two links each which, with the free ends, are secured to a bottom element 8 in the shape of a plate and a top element 9 likewise in the shape of a plate. One set of ends of the scissors is mounted with a pivot member 10,11 on the top and bottom element 8,9, while the other set of ends is mounted in a guide way 12,13 with a slide block 9,10. The two scissors 6,7 are mounted directly by the longitudinal edges of the bottom and top elements and are thereby placed with the largest possible mutual distance.

The two scissors 6,7 are in one side between the two links interconnected with a pivot axis 16, onto which a fork fitting 17 is secured. The scissor is driven by a linear actuator 18, having an activation rod 19 secured to the fork fitting 17. The actuator is, with its other end via a fork shaped rear mounting 20, secured to a vertical plate 21 on the bottom element 8. When the activation rod 19 of the actuator is retracted, the scissors 6,7 are retracted to the retracted position shown in FIG. 3, and when the activation rod 19 is extended the scissor is at the same time extended.

In FIGS. 4 and 5 is shown a modified version of the construction in FIGS. 2 and 3 with a particularly great stability in sideward direction, which is obtained by interconnecting the rods of the scissors 6,7 for forming frames. A particularly important contribution to the rigidness is attained by connection the slide blocks 14 of the guide way in the bottom element 8 to an intermediate plate piece 22. The same can be done to the guide way in the top element 9. In contradistinction to the construction in FIGS. 2 and 3 the actuator is, here with the rear mounting 21, secured to the bottom element 22, namely by means of a slide block mounted in a guide 23 on the top side of the bottom element. It should be noted that the scissor links are likewise connected by means of cross bar 24. In order to obtain a sufficient minimum height of the construction, the connection between the two scissors just above the actuator 18 are omitted to give space to this. Alternatively, the connection bar can be moved all the way out in the bolt joint and further be given a crank, in case this is not sufficient.

In FIG. 6-8 of the drawing, an embodiment of the column partially constructed from thin-plate is shown. The scissor mechanism is distinguished by having few components. The bottom and top elements 25,26 are thus identical and consist of a round going frame of profile tubes with a rectangular cross section. On each longitudinal side of the frame is mounted a guide 27,28, one end of which is secured to an end of a crossbeam 29 protruding from the frame, said crossbeam 29 mounted on one end of the frame 27,28. The other end of the guide 27,28 is mounted on a mount 30 protruding from the longitudinal side of the frame. Alternatively, the guide can run along the entire longitudinal side of the frame and be secured to a corresponding crossbeam in the other end of the frame. One leg 31 of the scissors consists of frames corresponding to the frames of the bottom and top elements 25,26. The other leg 32 in the scissor consists of thin-plate elements with bent side flaps 33. In each end of the thin-plate elements is a circular part 34, which constitutes one of the parts in a hinge. The end of the lower thin-plate element is pivotally hinged to the bottom element 25, while the end of the upper thin-plate element correspondingly is pivotally hinged to the top element 25. The two other ends of the thin-plate element are mutually pivotally hinged to each other via a through going shaft 35. At the centre the two thin-plate elements are pivotally hinged 36 to the two frames of the scissors. The lower part of the lower frame is pivotally hinged 37 to the guides 27 via a tube shaped slide mounting 38 on these and correspondingly, the upper part of the top frame in the scissors is pivotally hinged to the guide via a tube shaped slide mounting. A linear actuator 39 is, with its rear end 40, secured to the bottom element 25, while the actuator, with its front end 41 via a fork mounting 42, is secured to the upper member of the scissor. The fork mounting 42 currently consists of two plate elements extending from one end of the frame shaped scissor member to the other end. The shown embodiment for the scissor mechanism is distinguished by, in essential being made of four different elements, namely a frame element, which can be used both as top and bottom element, the frames of the scissors, and two thin-plate elements.

The advantage of the two first embodiments is that the actuator is attached to the interconnection element between the two scissor members. The last shown embodiment has further been improved in that the actuator is attached to the topmost member. In the last mentioned case the power curve is almost horizontal. Finally, the actuator can project down into the top and bottom elements with its rear end and front end respectively, which causes the curve of forces to be even more horizontal, corresponding to an, in essential, uniform force course during the entire length of stroke of the column.

As it appears, the stability of the columns is entirely located in the scissor mechanism so that the telescopic members can be constructed without stability, and thus as a simple enclosure, simply for counteracting something from being jammed in the scissor mechanism and also to function as dust and humidity protection. The two outermost telescopic members can simply be secured to the top and bottom elements respectively, while the intermediate member is loose and is brought along by the outermost member, when said outermost member is in its fully extended position and is pressed inwards when the column is retracted.

1. A lifting column comprising a number of telescopic members and a drive unit for extension of the members located internally therein, said lifting column (3,4) being intended for hospital and care beds of the art comprising a lower frame (1) and an upper frame (2) for a mattress, and where a lifting column (3,4) is placed under the bed at each end in its vertical longitudinal centre plane of the bed, said columns having respective ends connected to the lower frame (1) and the upper frame (2) so that the height of the upper frame can be adjusted by activating the drive unit of the lifting column and where the drive unit comprises a scissor mechanism with at least two links and driven by a motor driven spindle, wherein the scissor mechanism is constructed as a separate unit with two identical interconnected scissors (6,7) located between a bottom and top element (8,9) and by the longitudinal edges of these elements, and where the motor driven spindle is a separate linear actuator (18,39) with its one end secured to either the bottom or top element (8,9) and the other end of the actuator (18,39) is connected to a connection element (11) between the two scissors after the first scissor link, and the scissors with one set of ends are pivotally hinged (5,6) to the bottom and the top element (3,4) and with the other set of ends are placed displaceable (9,10) in relation thereto.

2. The lifting column according to claim 1, wherein the two scissors (6,7) are interconnected by means of shaft or rod elements (16,24).

3. The lifting column according to claim 1, wherein the two scissors (6,7) are interconnected, and one set of the scissor links is constructed as frames (31).

4. The lifting column according to claim 1, wherein the two scissors (6, 7) have links (32) constructed as thin-plate elements.

5. The lifting column according to claim 1, including at least one of the top or bottom elements (8,9) comprises a plate element.

6. The lifting column according to claim 5, wherein the lower end of the scissors with one set of ends is pivotally hinged (10) to the bottom element (8), while the other set of ends with a slide block (14) is mounted in a guide way (12) in the bottom element (8), and the slide blocks rigidly are interconnected (22).

7. The lifting column according to claim 1, including at least one of the top or bottom elements (8,9) comprises a frame (25,26).

8. The lifting column according to claim 7, including at least the lower end of the scissors with one set of ends is pivotally hinged (34) to the bottom element (8), while the other set of ends, with a slide bushing (38), is mounted in a guide way in the form of a tube shaped guide (27) in the bottom element (8).

9. The lifting column according to claim 1, including two scissor links and wherein the actuator with its one end is secured to a connection (16) between the two scissor links.

10. The lifting column according to claim 1, including two scissor links and wherein the actuator with its one end is secured to the topmost scissor link.
